(19) United States
(12) Patent Application Publication
(10) Pub. No.: US 2005/0188113 A1
(43) Pub. Date: Aug. 25, 2005

(54) System and method for performing an inter-system handoff between a high rate packet data mobile network and a voice mobile network

(76) Inventors: Sang-Do Lee, Seoul (KR); Hong-Sung Chang, Suwon-si (KR); Dong-Keon Kong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/784,230

(22) Filed: Feb. 24, 2004

(51) Int. Cl. G06F 15/16

(52) U.S. Cl. 709/249

(57) ABSTRACT

A system and method for transmitting packet data to a hybrid mobile terminal upon inter-system handoff is provided. The terminal communicates with High Rate Pack Data (HRPD) and voice mobile networks. A Packet Control Function (PCF) system converts received data for transmission to the terminal into Generic Routing Encapsulation (GRE) packet data, stores the GRE packet data combined with a GRE packet key in an active queue, transmits it to an access network, and stores packet data stored in the active queue in a dormant queue when receiving a link release message from the access network. The access network converts GRE packet data received from the PCF system into an Radio Link Protocol Data (RLP) packet, stores it in combination with a GRE packet sequence number, and transmits it to the terminal. When detecting air link loss with the terminal, the access network creates and transmits a link release message including a GRE packet sequence number that has not been transmitted to the terminal.

### PRIORITY

This application claims priority to an application entitled “SYSTEM AND METHOD FOR PERFORMING INTER-SYSTEM HANDOFF BETWEEN MOBILE NETWORK FOR HIGH RATE PACKET DATA COMMUNICATION AND MOBILE NETWORK FOR VOICE COMMUNICATION”, filed in the Korean Intellectual Property Office on Feb. 24, 2003 and assigned Serial No. 2003-11524, the contents of which are incorporated herein by reference.

### BACKGROUND OF THE INVENTION

1. Field of the Invention

The present invention relates to a system and method for performing a handoff in a mobile communication system, and more particularly to a system and method for performing a handoff between different types of mobile communication systems.

2. Description of the Related Art

Mobile communication systems have been developed to allow users to performing voice communication while in motion. As the popularity of mobile communication systems increases, demand for data communication, as well as voice communication also increases. In order to meet user demand, Short Message Service (SMS) messages, a High Rate Packet Data (HRPD) communication system, called First Evolution Data Only (1x EV-DO), has been introduced recently.

Basically, the HRPD communication system is not capable of providing voice communication service. Various methods have been suggested to provide voice communication service in the HRPD communication system. However, it is impossible for the suggested methods to provide voice service quality as high as mobile communication systems (for example, systems satisfying the IS-95 or IS-2000 specification) that are based on voice communication services. Since the HRPD mobile communication system, which is currently being installed to provide commercial services, does not allow voice communication, a hybrid terminal is under development.

The hybrid terminal is a mobile terminal that can perform data communication via the HRPD mobile communication system and can also perform voice communication with a voice communication system. In other words, the hybrid terminal is a mobile communication terminal that can perform communication while satisfying the IS-856 specification provided by the HRPD mobile communication system and can also perform voice communication while satisfying the IS-2000 specification. A mobile communication system based on voice communication and a HRPD mobile communication system that performs only data communication are described with reference to FIGS. 1A and 1B, respectively.

FIG. 1Aa is a diagram illustrating an example of a network for a Code Division Multiple Access (CDMA) 2000 mobile communication system 100 according to the IS-2000 specification. The mobile communication system 100 provides a voice communication service, a simple Internet data service, and an SMS service or the like to a mobile terminal 101 over a wireless channel between the mobile communication system and the terminal 101. The mobile terminal 101 forms a channel via a wireless link with a Base Transceiver Station (BTS) 102 that performs communication. The BTS 102 is connected to a Base Station Controller (BSC) 103, and forms a Radio Access Network (RAN) in a range where it may include a Packet Control Function (PCF) system 110. The BSC 103 is connected to a Mobile Switching Center (MSC) (or mobile communication switching system) 104. The MSC 104 may internally include a Visitor Location Register (VLR). The mobile communication system is provided with a Home Location Register (HLR) 105 to allow voice communication even when the location of the mobile terminal has changed. The MSC 104 in the mobile communication system 100 is connected to a Public Switched Telephone Network (PSTN) 106, whereby it can be connected to a wired communication system or other voice-based mobile communication systems.

The BSC 103 is connected to the Packet Control Function (PCF) system 110 to perform packet data communication. The PCF system 110 is connected to a Packet Data Service Node (PDSN) 111. The PDSN 111 provides data service to a mobile terminal at a relatively low rate, compared to a 1x EV-DO system. The PDSN 111 is connected to an Authentication, Authorization and Accounting (AAA) system 112 to provide a data service, and may also be connected to a Home Agent (HA) 113 for allocating a mobile Internet Protocol (IP) address to the mobile terminal. The HA 113 and the PDSN 111 are connected to the Internet 114. Mobile terminals capable of communicating with the CDMA 2000 system 100 configured as described above can receive a voice communication service, an Internet service, a Short Message Service (SMS) or the like in accordance with the IS-2000 specification.

FIG. 1B is a diagram illustrating an example of a network for an HRPD mobile communication system 130 according to the IS-856 specification. The configuration and operation of the network for the HRPD mobile communication system 130 according to the IS-856 specification will now be briefly described with reference to FIG. 1B. A mobile terminal 101 for the HRPD system 130 forms a channel via a wireless link with an Access Network Transceiver System (ANTS) 121. Through this channel, the mobile terminal 101 can receive a High Rate Packet Data service from the HRPD system 130. The ANTS 121 is connected to an Access Network Controller (ANC) 122. The ANTS 121 and the ANC 122 constitute an Access Network (AN) 123. The ANC 122 is connected to a Packet Control Function (PCF) system 110, and to an Access Network—Authentication, Authorization and Accounting (AN-AAA) system 124 in the HRPD system and performs authentication. The PCF system 110 is also connected to a Packet Data Service Node (PDSN) 111. The PDSN 111 provides a data service to 1x EV-DO mobile terminals. The PDSN 111 is connected to an AAA system 112 in a RADIUS scheme. The PDSN 111 is also connected to the Internet 114 and also to a Home Agent (HA) 125 for allocating a mobile IP address, which may be allocated to a 1x EV-DO mobile terminal. Mobile terminals capable of communicating with the 1x EV-DO system configured as described above can receive packet data services according to the IS-856 specification. A hybrid mobile terminal capable of receiving services from both the HRPD system and the CDMA 2000 system is shown in FIG. 2. The hybrid mobile terminal can switch between an operating mode for the HRPD system and an operation mode for the CDMA 2000 system.

FIG. 2 is a block diagram illustrating an example of a network in which the HPRD system and the CDMA 2000 system are used together. The configuration of the network for the combined use of the HPRD and CDMA-2000 systems will now be described with reference to FIG. 2.

A hybrid mobile terminal 201 (also called a “Hybrid Access Terminal (HAT)”) operates to receive a voice communication service and a data service according to the IS-2000 specification via a wireless link, and also operates to receive a high rate packet data service according to the IS-858 specification via a wireless link. A BTS 211 comprising the IS-2000 system forms a wireless link with the hybrid mobile terminal 201. The BTS 211 is connected to a BSC 212. The BTS 211 and the BSC 212 are collectively referred to as a “Base Station (BS)”. Elements subsequently connected to the BTS 211 have the same configuration as the corresponding elements described with reference to FIG. 1A, and only their reference numerals are different from those of the corresponding elements of FIG. 1A. An ANTS 221 communicates with the hybrid mobile terminal 210 via a wireless link according to the IS-856 specification. The ANTS 221 and an ANC 222 comprise an AN 223. Elements connected to the network at the next stage of the AN 223 have the same configuration as the corresponding elements described with reference to FIG. 1B, and only their reference numerals are different from those of the corresponding elements of FIG. 1B.

An example of paging for the hybrid mobile terminal 201 occurring while the terminal 201 receives 1x EV-DO packet data service will now be described with reference to FIG. 2. When the hybrid mobile terminal 201 receives the 1x EV-DO packet data service, the hybrid mobile terminal 201 maintains a connection with PDSN 225 through Point to Point Protocol (PPP). That is, when the hybrid mobile terminal 201 receives the packet data service, a channel according to the IS-856 specification has been established between the hybrid mobile terminal 201 and the 1x EV-DO base station (or ANTS) 221. A channel for providing the packet data service to the hybrid mobile terminal 201 has also been established between the ANTS 221 and the ANC 222. The ANC 222 is connected to the Packet Control Function (PCF) system 224 to establish a channel for communication with the hybrid mobile terminal 201 between the ANC 222 and the PCF system 224. A link for providing a packet data service to the hybrid mobile terminal 201 has been established between the PCF system 224 and the Packet Data Service Node (PDSN) 225. In this manner, a link for providing the 1x EV-DO service is established between the hybrid mobile terminal 201 and the PDSN 225, and packet data is transmitted over the established link.

If MSC 214 receives a call for transmission to the hybrid mobile terminal 201 from PSTN 215, the MSC 214 determines the location of the hybrid mobile terminal 201. It can be assume that calls received from the IS-2000 system are all voice calls. If there is such a voice call request, the MSC 214 determines the location of the hybrid mobile terminal 201. That is, the MSC 214 detects the BSC 212 and the BTS 211 where the hybrid mobile terminal 201 is located, and transfers a paging request message to the BTS 211. The BTS 211 then transfers the paging signal to the hybrid mobile terminal 201.

The hybrid mobile terminal 201 is currently receiving the packet data according to the 1x EV-DO standard, as described above. If a voice call is received when the packet data service is currently being provided to the hybrid mobile terminal 201, the terminal 201 performs a corresponding operation in response to the paging according to “a user preference setting” or “a fixed (or automatic) setting” for receiving-mode switching. The user preference setting and the fixed setting will be described first. The user preference setting is used to give priority to voice calls over packet data calls. In other words, if the user preference setting is set to give greater priority to voice calls over packet data calls, even if hybrid the mobile terminal 201 was currently receiving a 1x EV-DO service, the hybrid mobile terminal 201 stops operation for the 1x EV-DO service when a voice call is received, and responds to the voice call. This operation depends on the user preference setting that is set in the hybrid mobile terminal 201 by the terminal's user. The user can also set the user preference setting to allow the terminal 201 to operate in the opposite manner. In other words, if the user preference setting is set to give greater priority to packet data calls over voice calls, the hybrid mobile terminal 201 does not stop operation of the 1x EV-DO service even if a voice call is received. The hybrid mobile terminal 201 thus does not respond to the voice call.

The “fixed or automatic setting” has the opposite concept to the user preference setting. The manufacturer can set it to give priority to voice calls over packet data calls when it manufactures the hybrid mobile terminal 201. This is called the “fixed setting”. The user cannot change the fixed setting. In this case, if a voice call is received while the terminal 201 receives a 1x EV-DO service, the terminal 201 unconditionally responds to the voice call.

The following description will be given under the assumption that if the user preference setting is provided, it has been set to give greater priority to voice calls over 1x EV-DO services. It will also be assumed that if the fixed setting is provided, it has been set to give greater priority to voice calls over 1x EV-DO services.

In the case where either the user preference setting or the fixed setting is set as described above, if a voice call is received while the hybrid mobile terminal 201 receives a packet data service of the 1x EV-DO system, the terminal 201 stops processing for the packet data call and responds to the voice call. That is, the hybrid mobile terminal 201 suspends processing for the 1x EV-DO system, and responds to the call from the IS-2000 system. If the voice call service has been completed, the hybrid mobile terminal 201 resumes processing for the packet data of the 1x EV-DO system. Such an operation will be referred to as “inter-system handoff” in the following description. In other words, if the terminal 201 switches call service systems from the 1x EV-DO system to the IS-2000 system while the terminal 201 receives a packet data from the 1x EV-DO system, or if the terminal 201 switches the call service systems from the IS-2000 system to the 1x EV-DO system while the terminal 201 receives a voice communication service from the IS-2000 system, the switching operation will be referred to as the “inter-system handoff” in the following description.

If such an operation is performed, packet data loss may occur in the 1x EV-DO system. This will now be described in detail. The PDSN 225 continues to transmit packets for transmission to the hybrid mobile terminal 201 to the PCF system 224. Also the PCF system 224 continues to provide the packet data to the ANC 222 and the ANTS 221. In this case, if the hybrid mobile terminal 201 transmits packet data, the data transmission may be performed without causing any problems. However, if the hybrid mobile terminal 201 processes a voice call without responding to the 1x EV-DO system, it takes a long time for the 1x EV-DO system to release the packet data call due to a non-response from the terminal 201. Until the 1x EV-DO system releases the packet data call, the PCF system 224 continues to transmit the packet data to the ANC 222 and the ANTS 221.

In other words, the 1x EV-DO system continues to transmit packet data until it detects the call release due to non-response from the hybrid mobile terminal 201. In this case, it is impossible to retransmit packet data that has already been transmitted from the PCF system 224 to the ANTS 221 because the PCF system 224 does not store packet data until it recognizes the call release. The PCF system 224 stores the packet data in a queue or a buffer after it recognizes the call release. For this reason, even if the hybrid mobile terminal 201 resumes receipt of the call from the 1x EV-DO system, some part of the packet data is liable to be lost. This data loss results in a lowered quality of the service provided by the 1x EV-DO system.

One of the simplest ways to overcome such problems is to define a new signal used to allow the 1x EV-DO system to release the packet data call for a predetermined period of time when the hybrid mobile terminal 201 receives a paging signal for a voice call. However, it is not easy to implement this method because a new standard specification for the IS-856 must be defined. Even if a new standard specification of the IS-856 is defined, the entire system is subject to significant changes.

### SUMMARY OF THE INVENTION

Therefore, the present invention has been made in view of the above problem, and it is an object of the present invention to provide a system and method for performing inter-system handoff between a mobile network for High Rate Packet Data (HRPD) communication and a mobile network for voice communication, which prevents packet data loss that may occur when performing the inter-system handoff.

It is another object of the present invention to provide a system and method for performing inter-system handoff between a mobile network for High Rate Packet Data (HRPD) communication and a mobile network for voice communication, which prevents the Quality of Service (QoS) of a packet data service from decreasing when performing the inter-system handoff.

It is yet another object of the present invention to provide a system and method for performing inter-system handoff between a mobile network for High Rate Packet Data (HRPD) communication and a mobile network for voice communication, which guarantees the QoS of a packet data service when performing the inter-system handoff, while minimizing changes to the system.

In accordance with one aspect of the present invention, the above and other objects can be accomplished by the provision of a system for transmitting packet data to a hybrid mobile terminal capable of communicating with a mobile network for High Rate Pack Data (HRPD) communication and with a mobile network for voice communication when inter-system handoff occurs between the two mobile networks. The system comprising a Packet Control Function (PCF) system for receiving packet data for transmission to the hybrid mobile terminal, dividing the received packet data to create Generic Routing Encapsulation (GRE) packet data, storing the GRE packet data, together with a GRE packet key, in an active queue, transmitting the GRE packet data to an access network, and storing packet data stored in the active queue in a dormant queue when receiving a link release message from the access network. The system and method further comprising the access network for converting GRE packet data received from the PCF system to a Radio Link Protocol (RLP) packet, storing the RLP packet after adding a GRE packet sequence number to the RLP packet, transmitting the RLP packet to the hybrid mobile terminal, and, upon detection of loss of an air link with the hybrid mobile terminal, creating and transmitting a link release message including a GRE packet sequence number of a GRE packet that has not been transmitted to the hybrid mobile terminal.

In accordance with another aspect of the present invention, there is provided a method for transmitting packet data from a mobile network for HRPD communication to a hybrid mobile terminal capable of communicating with the mobile network for HRPD communication and with a mobile network for voice communication when inter-system handoff occurs between the two mobile networks. The method comprising the steps of a), by a PCF system, receiving packet data for transmission to the hybrid mobile terminal, storing the received packet data, together with a GRE packet header, in an active queue provided in the PCF system, and transmitting the packet data to an access network including the hybrid mobile terminal after conversion for transmission to access networks; b), by the access network, receiving packet data for transmission to the hybrid mobile terminal, converting the received packet data to RLP data, storing the RLP data, GRE packet data and a GRE packet sequence number of the packet data prior to the conversion into the RLP data and an RLP sequence number in a retransmission buffer, and transmitting the received packet data to the hybrid mobile terminal according to an RLP protocol. The system and method further comprising c), when detecting air link loss during data transmission to the hybrid mobile terminal, by the access network, creating a link release message including a GRE packet sequence number of a GRE packet, not having been transmitted to the hybrid mobile terminal, from among packet data stored in the retransmission buffer; and d), by the PCF system, creating a dormant queue when receiving a link release message including a GRE packet sequence number, and storing packet data corresponding to the GRE packet sequence number, and/or packet data transmitted subsequently thereto, in the created dormant queue.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a diagram illustrating an example of a network for a Code Division Multiple Access (CDMA) 2000 mobile communication system according to the IS-2000 specification;

FIG. 1B is a diagram illustrating an example of a network for a High Rate Packet Data (HRPD) mobile communication system according to the IS-856 specification;

FIG. 2 is a block diagram illustrating an example of a network in which the HPRD system and the CDMA 2000 system are used together;

FIG. 3 is a diagram illustrating an example of an internal configuration of a Packet Control Function (PCF) system according to an embodiment of the present invention;

FIG. 4 is a data flow diagram illustrating an example of how packet data flows when an access network receives Generic Routing Encapsulation (GRE) packet data according to an embodiment of the present invention;

FIG. 5 is a flow chart illustrating an example of a procedure for controlling an operation of the Access Node (AN) 223 in the First Evolution Data Only (1x EV-DO) system when a link is lost, according to an embodiment of the present invention; and

FIG. 6 is a flow chart illustrating an example of how a PCF system in the 1x EV-DO system operates when it receives a call release signal due to link loss according to an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals even though they are depicted in different drawings.

In the following description, a variety of specific elements such as detailed messages are shown. The description of such elements are used as examples. Those skilled in the art will appreciate that the present invention is not limited to the examples shown. In the following description of the present invention, a detailed description of known functions and configurations incorporated herein will be omitted for conciseness.

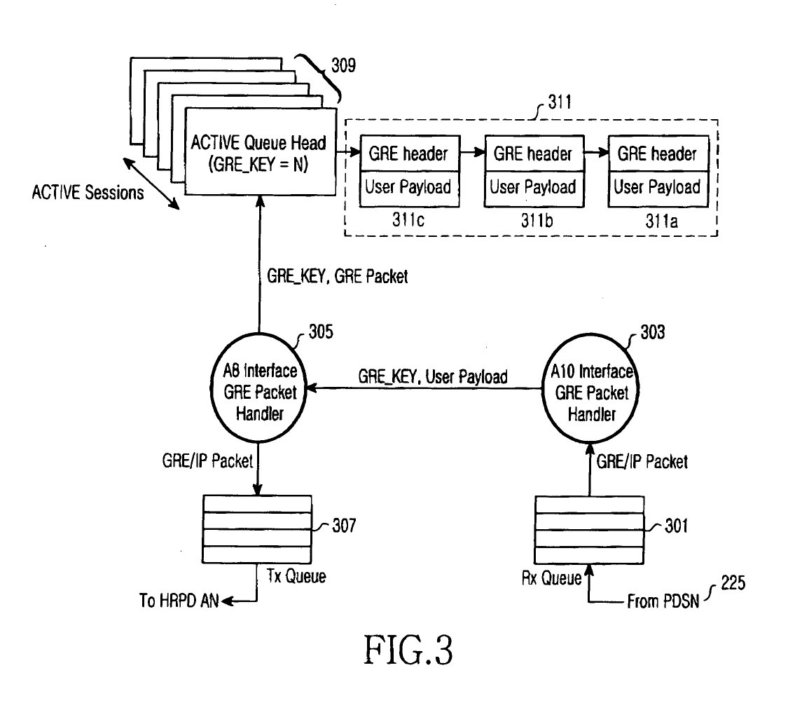

FIG. 3 is a diagram illustrating an example of an internal configuration of a Packet Control Function (PCF) system according to an embodiment of the present invention. The main internal configuration of the PCF system according to an embodiment of the present invention will now be described with reference to FIG. 3.

The PCF system includes a receiving queue (Rx Queue) 301 for temporarily storing data received from a Packet Data Service Node (PDSN) 225. The receiving queue 301 configures packet data received from the PDSN 225 into a size suitable for an interface processing time, etc., inside the PCF system. A first interface controller (A10 Interface GRE Packet Handler) 303 reads the data stored in the receiving queue 301. The term “GRE” refers to Generic Routing Encapsulation for implementing a simplified routing capsule.

Specifically, the first interface controller 303 reads packet data stored in the receiving queue 301, and outputs the data after adding a GRE packet key “GRE_KEY” to user data (or a user payload). The data output from the first interface controller 303 is input to a second interface controller (A8 Interface GRE Packet Handler) 305. The second interface controller 305 converts the input packet data to a GRE/IP packet, and then outputs it to a transmitting queue (Tx Queue) 307. The second interface controller 305 also stores GRE packet data, including the GRE packet key “GRE_KEY” according to an embodiment of the present invention, in an active queue 309 that includes active sessions according to an embodiment of the present invention.

The packet data is stored in the active queue 309 as denoted by reference numeral 311 in FIG. 3. A corresponding GRE header is added to each of the user payloads, and the added data is stored in the active queue 309 in the order in which it is input to the queue 309 (i.e., in the order of 311a, 311b, 311c, . . . in FIG. 3). The procedure in which the data stored in the active queue 309 is transferred to the hybrid mobile terminal 201 will be described with reference to the following data flow diagram and the following flow charts.

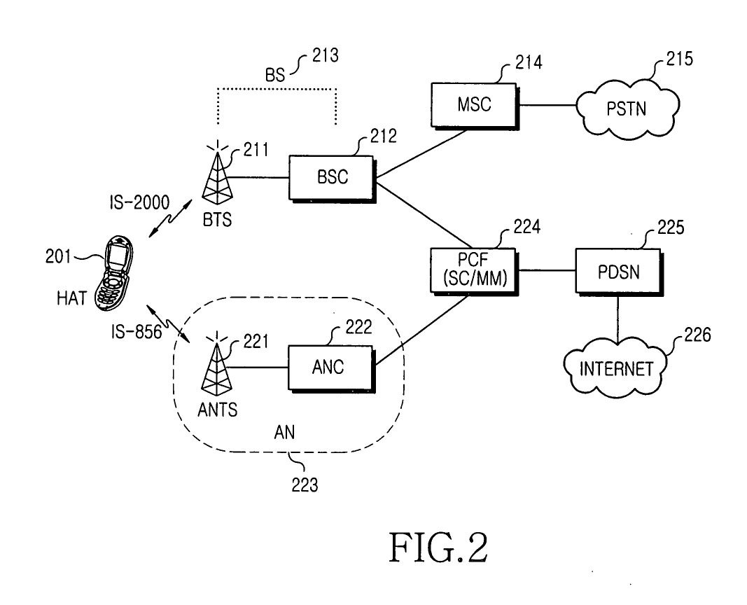

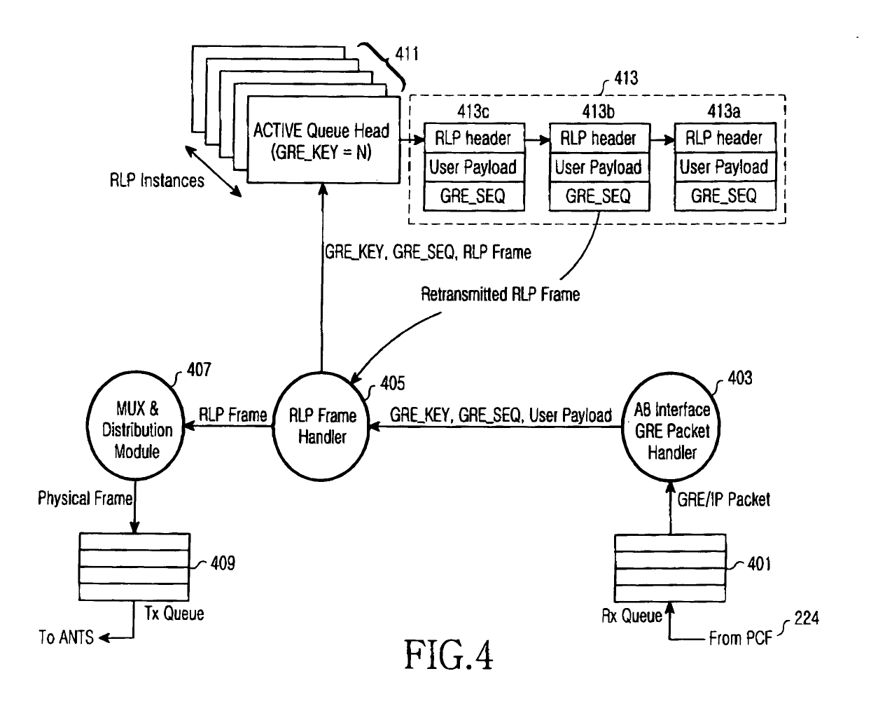

FIG. 4 is a data flow diagram illustrating an example of how packet data flows when the Access Network (AN) receives GRE packet data according to an embodiment of the present invention. In an embodiment of the present invention, the Access Network Controller (ANC) 222 in the AN 223 of FIG. 2 includes the blocks shown in FIG. 4. In another embodiment of the present invention, the (Access Network Transceiver Station) ANTS 221 may include the blocks of FIG. 4. However, it is more preferable that the blocks of FIG. 4 are included in the ANC 222 that performs Radio Link Protocol (RLP) processing. The main internal configuration of the Access Network Controller (ANC) 222 in the AN 223 according to the embodiment of the present invention will now be described with reference to FIG. 4.

The ANC 222 included in the AN 223 receives GRE packet data output from the PCF system 224. The GRE packet data received from the PCF system 224 is input to a receiving buffer (Rx Queue) 401, and is sequentially stored. A first interface controller (A8 Interface GRE Packet Handler) 403 reads the packet data stored in the receiving buffer 401 in the order that it is stored in the receiving buffer 401, and outputs the read data after performing processing according to the A8 interface. Accordingly, the packet data is output from the first interface controller 403 after a GRE packet key “GRE_KEY”, together with a GRE packet sequence number “GRE_SEQ”, is added to a corresponding user payload. In other words, the packet data is output from the first interface controller 403 after it is added with a sequence number and a key value corresponding to the GRE packet. The packet data output from the first interface controller 403 is input to a frame controller (RLP Frame Handler) 405.

The frame controller 405 converts the A8 interface-based packet data received from the controller 403 into an RLP frame, and outputs the converted RLP frame. The RLP frame output from the frame controller 405 is input to a multiplexing & distribution module 407. For retransmission according to the RLP protocol, the frame controller 405 also outputs the RLP frame to an RLP retransmission buffer 411, so that the buffer 411 stores the RLP frame. Here, the frame controller 405 allows the packet data to be stored together with the GRE packet sequence number “GRE_SEQ” and the GRE packet key “GRE_KEY” corresponding to the header of the frame received from the first interface controller 403. That is, the packet data is stored in the retransmission buffer 411 as denoted by reference numeral 413. In more detail, the packet data is stored in the RLP retransmission buffer 411 in the following manner. The packet data is stored in the RLP retransmission buffer 411 on a packet-by-packet basis in the order in which it is transmitted (i.e., in the order of 413a, 413b, 413c, . . . in FIG. 4), where each packet as a storage data unit includes an RLP header, a user payload (or user data) and a GRE packet sequence number “GRE_SEQ”. When an RLP protocol layer requests retransmission of packet data stored in the RLP retransmission buffer 411, the frame controller 405 reads the packet data.

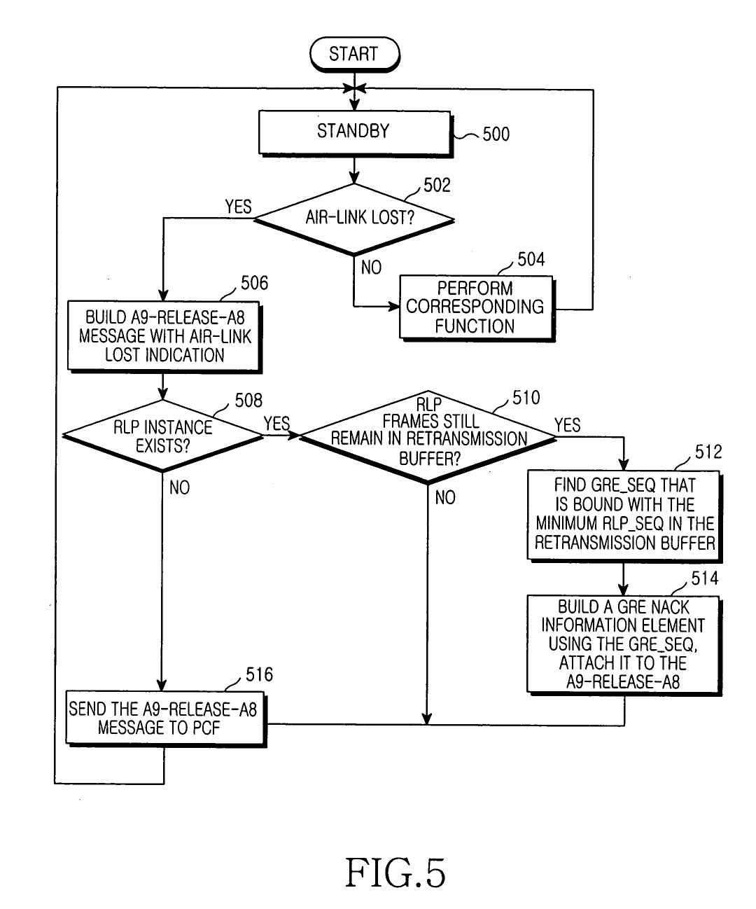

Upon receipt of RLP data, the multiplexing & distribution module 407 converts the received RLP data into a physical frame and outputs it to a transmitting buffer 409. The transmitting buffer 409 transfers the physical frame to the ANTS 221, so as to provide a corresponding packet data service to a hybrid mobile terminal or a 1x EV-DO terminal. In addition, the frame controller 405 according to the embodiment of the present invention can perform various control operations as illustrated in FIG. 5 (described below), and can also control other operations of the ANC 222. Upon receipt of a signal indicating air link loss from the ANTS 221, the frame controller 405 refers to data currently stored for retransmission in the RLP retransmission buffer 411, and requests the corresponding retransmission from the PCF system 224. While requesting the retransmission, the frame controller 405 checks and detects the GRE packet's sequence number, and transmits a message for requesting interface release due to the link loss, said message including an indication of whether an air link is lost or the like. FIG. 4 does not show an apparatus for interfacing the message input to or output from the frame controller 405.

FIG. 5 is a flow chart illustrating an example of a procedure for controlling an operation of the AN 223 in the 1x EV-DO system when a link is lost, according to an embodiment of the present invention. All the processes shown in FIG. 5 are also performed in the ANC 222, while the frame controller 405 performs the control operations as described above with reference to FIG. 4.

The frame controller 405 in the ANC 222 maintains a standby state at step 500. The term “standby state” refers to a state of waiting for the occurrence of a specific event without performing the operation. The frame controller 405 maintains the standby state until the specific event occurs. To determine whether the specific event occurs, the frame controller 405 proceeds to step 502. At step 502, the frame controller 405 determines whether it is receiving a signal indicating air link loss from the ANTS 221. If the determination at step 502 is that an event indicating air link loss occurs, the frame controller 405 proceeds to step 506. Otherwise, the frame controller 405 proceeds to step 504 to perform a control operation based on the event.

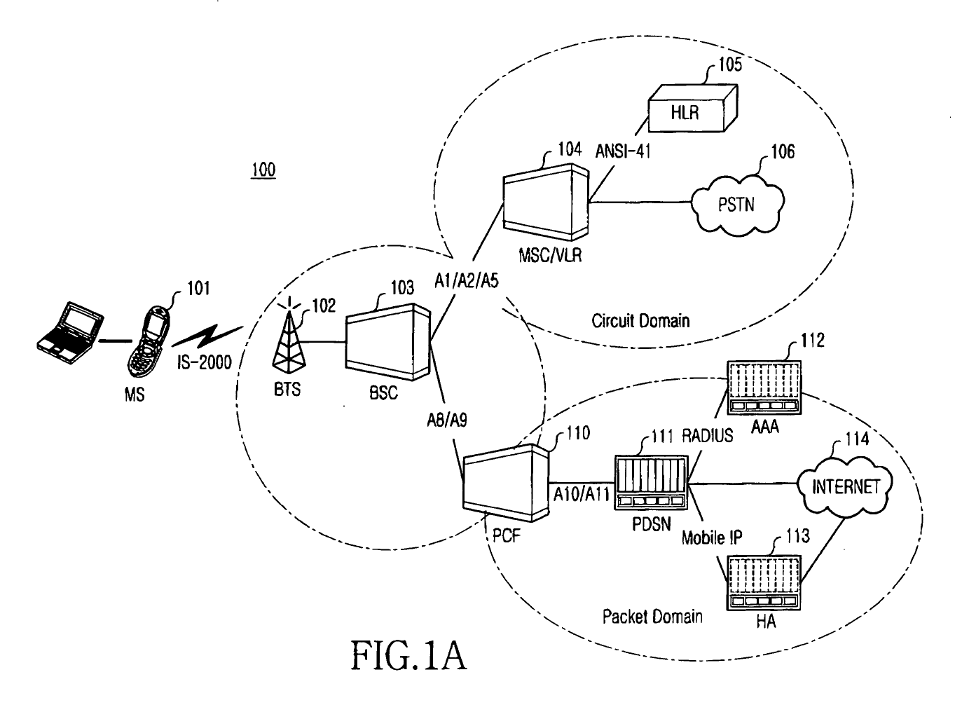

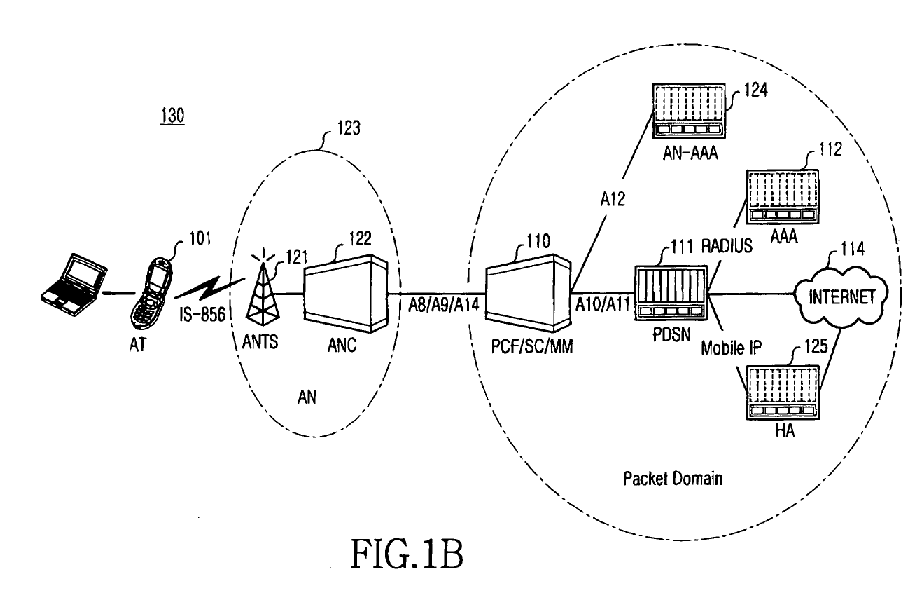

When proceeding from step 502 to step 506, the frame controller 405 creates a message (A9-Release-A8) for releasing A9 and A8 interfaces. For example, the frame controller 405 creates a message for releasing A8 and A9 interfaces connected between the ANC 222 and the PCF system 224, as shown in FIG. 1B. The created message for releasing the interfaces includes air link loss indication of whether an air link is lost. Then, the frame controller 405 proceeds to step 508 to check whether there is a Radio Link Protocol (RLP) occurrence. The purpose of checking whether there is an RLP occurrence is to overcome the problems described in the prior art. In other words, the existence of an RLP occurrence indicates the existence of data currently being transmitted. Therefore, RLP occurrence is checked to determine whether there is a need to compensate for air link loss.

If there is no RLP occurrence at step 508, the frame controller 405 proceeds to step 516; otherwise, it proceeds to step 510. First, if the frame controller 405 proceeds from step 508 to step 516, since there is no RLP occurrence, the frame controller 405 transmits a message for releasing A8 and A9 interfaces to the PCF system 224. This operation is performed if the mobile terminal is currently receiving no 1x EV-DO service.

On the other hand, if the frame controller 405 proceeds from step 508 to step 510, the frame controller 405 determines whether there is an RLP packet in the retransmission buffer 411. This determination is performed because the RLP packet exists in the retransmission buffer 411 if the transmission is ongoing. On the contrary, if the transmission is not ongoing, it indicates that there is no RLP packet data for transmission although the RLP occurrence exists. Thus, if the determination at step 510 is that there is no data in the retransmission buffer 411, the frame controller 405 proceeds to step 516.

On the other hand, if the determination at step 510 is that there is an RLP frame for transmission in the retransmission buffer 411, the frame controller 405 proceeds to step 512. At step 512, the frame controller 405 detects a GRE packet sequence number from a minimum RLP sequence number (MIN. RLP_SEQ) of an RLP packet stored in the retransmission buffer 411. One reason why this detection is performed is that an RLP packet (user payload), added with a GRE packet sequence number “GRE_SEQ” and an RLP header according to an embodiment of the present invention, is stored in the retransmission buffer 411. Another reason detection is performed is that the transmission is performed in the order of the RLP header (i.e., in increasing order of the RLP sequence number included in the RLP header, for example, in the order of RLP sequence numbers 0, 1, 2, 3, . . . ) so that the mobile terminal may have failed to receive an RLP packet with the minimum value (MIN. RLP_SEQ) that will be retransmitted. In such a manner, it is possible to detect a GRE packet sequence number from an RLP header. If the frame controller 405 detects the GRE packet sequence number “GRE_SEQ”, it proceeds to step 514 to create a negative acknowledgement (NACK) signal for the GRE packet on the basis of the GRE packet sequence number. The NACK signal for the GRE packet is added to a signal (A9-Release-A8) for releasing A8 and A9 interfaces. The frame controller 405 then proceeds to step 516 to transmit the created signal to the PCF system 224.

In order to implement the above configuration, it is required to somewhat modify the A8/A9 interface release signal. Fields to be modified can be expressed as shown in the following table.

TABLE 1

| Information | | Element | | | |
|---|---|---|---|---|---|
| Element | Value | Direction | | Type | |
| A 9 Message Type | 04H | AN → PCF | | M | |
| . . . | . . . | . . . | . . . | | . . . |
| Cause | IFH(air link | AN → PCF | 0 | | R |
| | lost) | | | | |
| . . . | . . . | . . . | . . . | | . . . |
| A8 NACK | GRE_KEY, | AN → PCF | 0 | | C |
| | GRE_SEQ | | | | |

In table 1, information elements according to the embodiment of the present invention are a Cause field and an A8 NACK field. In Table 1, arrows “→” indicate that the transmission is performed in the direction from the Access Network (AN) to the Packet Control Function (PCF) system. The A8 NACK field includes GRE_KEY and GRE_SEQ according to the embodiment of the present invention. The Cause field indicates air link loss. In the “Type” entries of Table 1, ‘0’, ‘R’ and ‘C’ indicate that the addition is optional, required, and conditionally required, respectively.

A message for the A8 NACK information elements may be configured as the shown in the following table.

TABLE 2

| | | | | | | | | |
|---|---|---|---|---|---|---|---|---|
| 7 | 6 | 5 | 4 | 3 | 2 | 1 | 0 | Octet |

| A14 Element Identifier = [90H] | | | 1 |
|---|---|---|---|
| Type = 01H (GRE) | | | 2 |
| Length = 08H | | | 3 |
| (MSB) | | | 4 |
| | GRE_KEY | | 5 |
| | | (LSB) | 6 |
| | | | 7 |
| (MSB) | | | 8 |
| | | | 9 |
| | GRE_SEQ | | 10 |
| | | (LSB) | 11 |

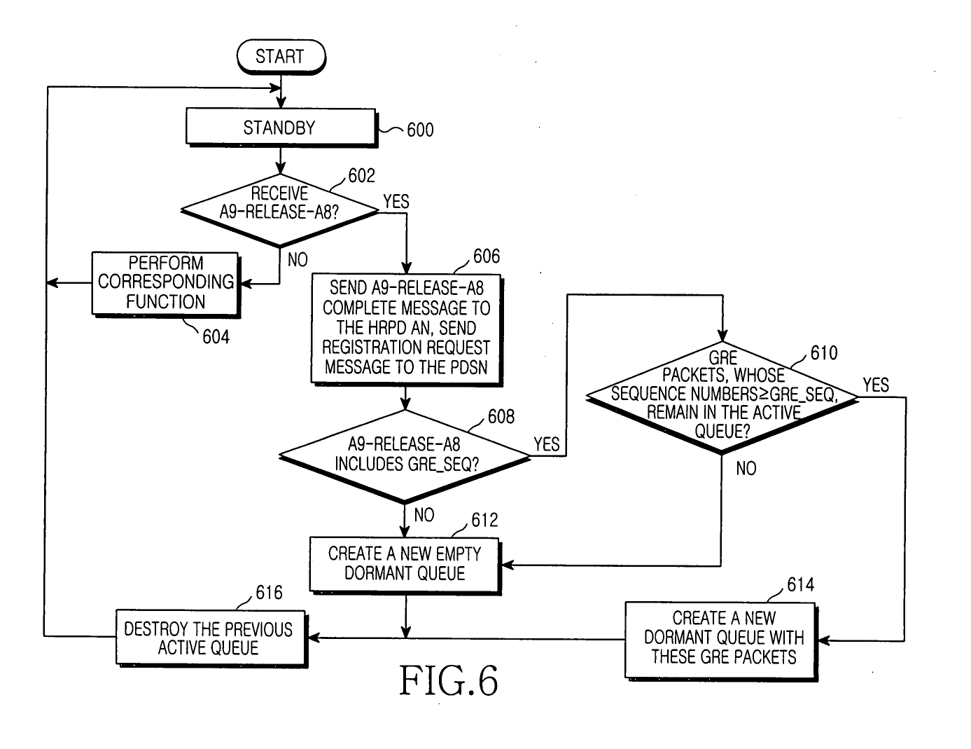

The PCF system 224 operates as illustrated in FIG. 6 (described below) to receive a message as shown in the above Table 1 (including Table 2).

FIG. 6 is a flow chart illustrating an example of how the PCF system 224 in the 1x EV-DO system operates when it receives a call release signal due to link loss according to an embodiment of the present invention.

The PCF system 224 maintains a standby state at step 600. The term “standby state” refers to a state of waiting for the occurrence of a specific event. When the specific event occurs during the standby state, the PCF system 224 proceeds to step 602 to determine whether it receives a message (A9-Release-A8) for releasing A8 and A9 interfaces. If the determination at step 602 is that it has received the A8/A9 interface release message, the PCF system 224 proceeds to step 606. Otherwise, the PCF system 224 proceeds to step 604 to perform a corresponding function. If the PCF system 224 has received the A8/A9 interface release message, and thus proceeds to step 606, the PCF system 224 transfers a message (A9-Release-A8 complete message) for completing the release of the A8 and A9 interfaces to an ANC in a corresponding AN. At step 606, the PCF system 224 also transfers a registration request message to the PDSN that serves to transfer packet data to the mobile terminal.

Then, at step 608, the PCF system 224 determines whether the received A8/A9 interface release message includes a GRE packet sequence number “GRE_SEQ”. If the checked result at step 608 is yes, the PCF system 224 proceeds to step 610; otherwise it proceeds to step 612. The purpose of determining whether the A8/A9 interface release message includes the sequence number GRE_SEQ is to check whether the ANC, which has transmitted the A8/A9 interface release message, was transmitting packet data to the mobile terminal. If the ANC was transmitting the packet data to the mobile terminal, the A8/A9 interface release message will include the sequence number GRE_SEQ; otherwise, it will not include the sequence number GRE_SEQ. Accordingly, if the PCF system 224 proceeds to step 612, it indicates that the ANC was not transmitting the packet data to the mobile terminal.

If the PCF system 224 proceeds from step 608 to step 612, it creates a new empty DORMANT queue according to the embodiment of the present invention, which stores received packet data for a mobile terminal whose air link has been released. When the PCF system 224 receives new data to be transmitted to a mobile terminal, it stores the received data in the empty dormant queue. After creating the new empty dormant queue, the PCF system 224 proceeds to step 616 to destroy a previous ACTIVE queue.

On the other hand, if the checked result at step 608 is that the access network was transmitting packet data to the mobile terminal, the PCF system 224 proceeds to step 610. At step 610, the PCF system 224 compares GRE packet sequence numbers stored in an active queue (i.e., a queue currently in an active state) with a GRE packet sequence number received from the access network. If the compared result at step 610 is that the received GRE packet sequence number is larger than those stored in the active queue, the PCF system 224 proceeds to step 612, otherwise it proceeds to step 614. The purpose of comparing the GRE packet sequence numbers is to determine whether the GRE packet sequence number received from the access network is a normal sequence number. In the normal case, the PCF system 224 cannot receive a GRE packet sequence number larger than GRE packet sequence numbers transmitted to the access network and simultaneously stored in the active queue. Accordingly, in the normal case, the PCF system 224 proceeds to step 614, otherwise it proceeds to step 612. The steps 612 and 616 are the same or similar as described above.

If it receives a normal GRE packet sequence number, the PCF system 224 proceeds to step 614. At step 614, it is required for the PCF system 224 to store a GRE packet corresponding to a GRE packet sequence number of a GRE packet, which has been stored in the active queue, and/or GRE packets subsequent to the corresponding GRE packet, in a new empty dormant queue because the corresponding and subsequent GRE packets have failed to be transmitted to the mobile terminal. The PCF system 224, thus, creates the new dormant queue for storing the corresponding GRE packet, which has been stored in the active queue, and/or the subsequent GRE packets, and stores the corresponding and subsequent GRE packets, which have been stored in the active queue, in the newly created dormant queue. This storage operation makes it possible to resume transmission of data that has been previously transmitted when the mobile terminal's user wishes to receive the data via an air link in the next available time period. Accordingly, in the case where an air link is released as a voice call is received from the IS-2000 system while a hybrid mobile terminal receives a packet data service from the 1x EV-DO system as described above in the prior art, the terminal can resume receipt of packet data that it was receiving from the 1x EV-DO system by reconnecting to the 1x EV-DO system via an air link after the voice call has been completed. After performing step 614, the PCF system 224 proceeds to step 616 to destroy the active queue that was receiving the packet data from the PDSN in the active state.

As apparent from the above description, an inter-system handoff system and method according to the present invention can prevent packet data loss that may occur when inter-system handoff occurs between a high rate packet data mobile network and a voice mobile network. The data loss prevention makes it possible to reduce unnecessary retransmission of the same packet between wired and wireless networks, thereby reducing system load.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A system in a mobile network for High Rate Pack Data (HRPD) communication for transmitting packet data when inter-system handoff occurs between the mobile network for HRPD communication and a mobile network for voice communication, said system comprising:
a hybrid mobile terminal capable of communicating with both the mobile networks; and
a Packet Control Function (PCF) system for receiving packet data for transmission to the hybrid mobile terminal, dividing the received packet data to create Generic Routing Encapsulation (GRE) packet data, storing the GRE packet data, together with a GRE packet key, in an active queue, transmitting the GRE packet data to an access network, and storing packet data stored in the active queue in a dormant queue when receiving a link release message from the access network.

2. The system according to claim 1, wherein, upon receipt of the link release message including the GRE packet sequence number, the PCF system transfers packet data, corresponding to a sequence number appointed by the GRE packet sequence number, from among data for the hybrid mobile terminal stored in the active queue, and/or packet data subsequent to said packet data corresponding to the sequence number, to the dormant queue, and then destroys the active queue.

3. The system according to claim 1, wherein the PCF system transmits packet data for transmission to a mobile terminal, stored in the dormant queue, to the mobile terminal when an air link is established to the mobile terminal.

4. The system according to claim 1, wherein upon receipt of the link release message including the GRE packet sequence number, the PCF system stores packet data, which is transmitted from a Packet Data Service Node (PDSN) to the hybrid mobile terminal, sequentially in the dormant queue.

5. A method for transmitting packet data in a Packet Control Function (PCF) system when inter-system handoff occurs between a mobile network for High Rate Pack Data (HRPD) communication and a mobile network for voice communication, said method comprising the steps of:
receiving packet data for transmission to a hybrid mobile terminal, storing the received packet data, together with a Generic Routing Encapsulation (GRE) packet header, in an active queue provided in the PCF system, and transmitting the packet data to an access network;
creating a dormant queue when receiving a link release message including a GRE packet sequence number, and storing packet data corresponding to the GRE packet sequence number, and/or packet data transmitted subsequently thereto, on the created dormant queue.

6. The method according to claim 5, further comprising the step of:
transmitting by the PCF system, a link release complete signal for completing release of a link with the access network when receiving a link release signal including a GRE sequence number, and then releasing the link with the access network.

7. The method according to claim 5, further comprising the step of:
destroying by the PCF system, the active queue after storing packet data of the active queue in the dormant queue.

8. The method according to claim 5, further comprising the step of:
creating and transmitting by the PCF system, a message for requesting that a service node for performing transmission of packet data to the hybrid mobile terminal to store packet data for transmission and also to switch to a standby state, after storing packet data of the active queue in the dormant queue.

9. A system in a mobile network for High Rate Pack Data (HRPD) communication for transmitting packet data when inter-system handoff occurs between a mobile network for HRPD communication and a mobile network for voice communication, said system comprising:
a hybrid mobile terminal capable of communicating with both the mobile networks; and
an access network for converting a Generic Routing Encapsulation (GRE) packet data received from a Packet Control Function (PCF) system to a Radio Link Protocol (RLP) packet, storing the RLP packet after adding a GRE packet sequence number to the RLP packet, transmitting the RLP packet to the hybrid mobile terminal, creating a link release message including the GRE packet sequence number of a GRE packet that has not been transmitted to the hybrid mobile terminal, upon detection of loss of an air link with the hybrid mobile terminal, and transmitting the created link release message to the PCF system.

10. The system according to claim 9, wherein upon receipt of packet data from the system, the access network stores user data added with the GRE packet sequence number and an RLP header, so that they are matched together.

11. A method for transmitting packet data from an access network to a hybrid mobile terminal capable of communicating with a mobile network for High Rate Pack Data (HRPD) communication and with a mobile network for voice communication when inter-system handoff occurs between the two mobile networks, said method comprising the steps of:
by the access network, receiving packet data for transmission to the hybrid mobile terminal, converting the received packet data to Radio Link Protocol (RLP) data, storing the RLP data, Generic Routing Encapsulation (GRE) packet data and a GRE packet sequence number of the packet data prior to the conversion into the RLP data and an RLP sequence number in a retransmission buffer, and transmitting the received packet data to the hybrid mobile terminal according to an RLP protocol; and
when detecting air link loss during data transmission to the hybrid mobile terminal, by the access network, creating a link release message including a GRE packet sequence number of a GRE packet, which has not been transmitted to the hybrid mobile terminal, from among packet data stored in the retransmission buffer, and transmitting the created link release message to a Packet Control Function (PCF) system.
